(19) United States
(12) Patent Application Publication
(10) Pub. No.: US 2013/0176192 A1
(43) Pub. Date: Jul. 11, 2013

(54) Extra-sensory perception sharing force capability and unknown terrain identification system

(71) Applicants: Kenneth Varga, Peoria, AZ (US); John Hiett, Tempe, AZ (US)

(72) Inventors: Kenneth Varga, Peoria, AZ (US); John Hiett, Tempe, AZ (US)

(21) Appl. No.: 13/385,039

(22) Filed: Jan. 30, 2012

Related U.S. Application Data
(60) Provisional application No. 61/629,043, filed on Nov. 12, 2011.
(60) Provisional application No. 61/626,701, filed on Sep. 30, 2011.

(51) Int. Cl. G09G 3/04

(52) U.S. Cl. CPC G09G 3/04
USPC 345/7

(57) ABSTRACT

An occlusion or unknown space volume confidence determination, and planning system using databases, position, and shared real time data to determine unknown regions allowing planning and coordination of pathways through space to minimize risk. Data such as from cameras, or other sensor devices can be shared and routed between units of the system. Hidden surface determination, also known as hidden surface removal (HSR), occlusion culling (OC) or visible surface determination (VSD), can be achieved by identifying obstructions from multiple sensor measurements and incorporating relative position with depth between sensors to identify occlusion structures. Weapons ranges, and orientations are sensed, calculated, shared, and can be displayed in real time. Data confidence levels can be highlighted from time, and frequency of data. The real time data can be displayed stereographically for and highlighted on a display.

### CROSS-REFERENCE TO RELATED APPLICATIONS

This application claims benefit of the Nov. 12, 2011 filing date of Provisional application No. 61/629,043 pursuant to 35 U.S.C. sec. 119. See also U.S. Ser. No. 61/626,701, U.S. patent application Ser. No. 12460552

### FEDERALLY SPONSORED RESEARCH

None.

### SEQUENCE LISTING

None.

### BACKGROUND

This application allows real time identification of critical force capability effectiveness zones and occlusion or unknown zones near those forces. Personnel, vehicles, ships, submarines, airplanes, or other vessels are often occluded by terrain surfaces, buildings, walls, or weather, and sensor systems may be incapable of identifying objects on the other sides of the occlusions, or objects may simply be outside of range of sensors or weapons capabilities. This invention helps field commanders to identify these critical occlusion zones, track targets amongst occlusions, as well as threat ranges from these occlusion zones, in advance of force actions, and to share the data between systems in real time to make better more informed decisions. This effectively makes each individual system an extra-sensory perception sharing system, by sharing perspectives outside, or exterior to an individual local system.

One example of this problem of individual human perception can be well illustrated by the 1991 Battle of 73 Easting during the first Gulf War during adverse weather conditions that severely restricted aerial scouting and cover operations. Although successful for the U.S. side, asymmetrical force risk was higher than necessary because although it appeared to be a flat featureless desert, the occluding subtle slight slope of the terrain was not initially recognized to occlude visual battlefield awareness by a tank commander named HR McMaster. The subtle slight land slope occlusion prevented identifying awareness of critical real-time data of enemy numbers, positions, and capabilities in the absence of advanced aerial reconnaissance due to severe weather conditions.

The purpose of this invention is to help field commanders become more acutely aware of sloped or other terrain or regions that are outside their field of visual, perceptual or sensory awareness of which can contain fatal hazards, particularly when these zones have not been scouted for hazards in real time. The application of this invention will allow the field commander to adjust actions to eliminate or avoid the hazards of the occlusion zones. The limitation of the perceptual capability of one pair of human eyes and one pair of human ears on an individual or mobile unit can be reduced by utilizing multiple users remotely tapped into one user's omni-directional sensor system(s) and can thus maximize their perceptual vigilance and capability of the one user or unit through remote robotic control and feedback of the individual or unit carried sub-systems. Maximized perceptual vigilance can be achieved from tapping into near full immersion sensors, which can include sensing vision three dimensional (3D) display from depth cameras (optics), temperature, stereo or surround or zoom-able microphone systems, pinching, poking, moisture, vestibular balance, body/glove sensation while producing an emulated effect of this remotely producing nearly full sensory immersions. Tracking, history, force capability, prediction, as well as'other data can be augmented onto the display system to augment reality and to further enhance operations.

Prior Shared Perception Systems

There are many real time three dimensional sensor sharing systems in the prior art that incorporate multiple sensors and multiple users as found in U.S. Pat. Nos. 8,050,521; 7,734,386; 7,451,023; and 7,378,963, as well as in U.S. Pat. App. Nos. 2011/0248847, 2011/0216059, 2011/0025684, 2010/0017046, 2010/0001187, 2009/0086015, 2009/0077214, 2009/0040070, 2008/0221745, 2008/0218331, 2008/0052621, 2007/0103292, also described in S. MORITA, “Internet Telepresence by Real-Time View-Dependent Image Generation with Omnidirectional Video Camera”; FOYLE, “Shared Situation Awareness: Model-based Design Tool”; FIREY, “Visualization for Improved Situation Awareness (VISA)”; PERLA, “Gaming and Shared Situation Awareness”; NOFI, “Defining and Measuring Shared Situational Awareness”, GRUBB, “VIMS Challenges in the Military”; GARSTK, “An Introduction to Network Centric Operations”.

Prior Image 3D Overlay Systems

Image overlay systems over a 3D surface are described in U.S. Pat. App. No. 2010/0231705, 2010/0045701, 2009/0322671, 2009/0027417, 2007/0070069, 2003/0210228 also described in AVERY, “Improving Spatial Perception for Augmented Reality X-Ray Vision”; TSUDA, “Visualization Methods for Outdoor See-Through Vision”; SUYA YOU, “Augmented Reality—Linking Real and Virtual Worlds”; VAISH, “Reconstructing Occluded Surfaces using Synthetic Apertures: Stereo, Focus and Robust Measures”; FRICK, “3D-TV LDV CONTENT GENERATION WITH A HYBRID TOF-MULTICAMERA RIG”; LIU, “Image De-fencing”; KECK, “3D Occlusion Recovery using Few Cameras”; LIVINGSTON, “Resolving Multiple Occluded Layers in Augmented Reality”; and KUTTER, “Real-time Volume Rendering for High Quality Visualization in Augmented Reality”.

Prior Occluded Target Tracking Systems

Tracking objects amongst occlusions are described in JOSHI, “Synthetic Aperture Tracking: Tracking through Occlusions”; TAO YANG, “Continuously Tracking and See-through Occlusion Based on A New Hybrid Synthetic Aperture Imaging Model”

We are not aware of any systems mentioned in the referenced prior art, or elsewhere, that identify, track, display, and determine shared occluded system spaces as well as identify force capabilities and displaying these capabilities in real time.

### SUMMARY

This invention allows for identifying the real time range capability of a force or forces, their weapons, real-time orientation (pointing direction) of weapons (with integrated orientation sensors on weapons) and weapons ranges, equipment or other capabilities, as well as sensor and visual ranges during multiple conditions of night and day and varying weather conditions. From identified real-time zone limitations based on weapons ranges, occlusions, terrain, terrain elevation/topographical data, buildings, ridges, obstructions, weather, shadows, and other data, field commander decisions are able to be made more acutely aware of potential hazard zones, to avoid or make un-occluded and aware of, and be better prepared for in order to reduce operational risks. The system can be designed to implement real time advanced route planning by emulating future positions and clarifying occlusions and capabilities in advance, thus allowing for optimal advanced field positioning to minimize occlusion zones, avoid hazards from, and maximize situational awareness.

### DRAWINGS

FIG. 1A is an example of the occlusion problem of a mountainous region with many mountain ridges (layers) and illustrates how the occluded zones can be identified and viewed via real time wireless information sharing between multiple units.

FIG. 1B is a real-time Heads-Up Display (HUD) of occlusion layer viewing penetration of mountain ridges of FIG. 1A that allows the operator to look through and control the viewing layers of occlusion to see through the mountain layers.

FIG. 2A is a real-time battlefield force capability and occlusion hazard awareness map showing weapon range capabilities and unit occlusions.

FIG. 2B is a real-time HUD of occlusion layer viewing penetration of the mountain ridge of FIG. 2A that utilizes transformed image data from other unit with other unit's occlusion zones shown.

FIG. 3A is a real-time building search where multiple personnel are searching rooms and sharing data where un-identified regions are shown.

FIG. 3B is a real-time HUD of occlusion layer viewing penetration of building walls of FIG. 3A that utilizes transformed image data from other units.

FIG. 4A is a block diagram of the environment extra-sensory perception sharing system hardware.

FIG. 4B is a flow chart of the extra-sensory perception sharing system.

### DETAILED DESCRIPTION

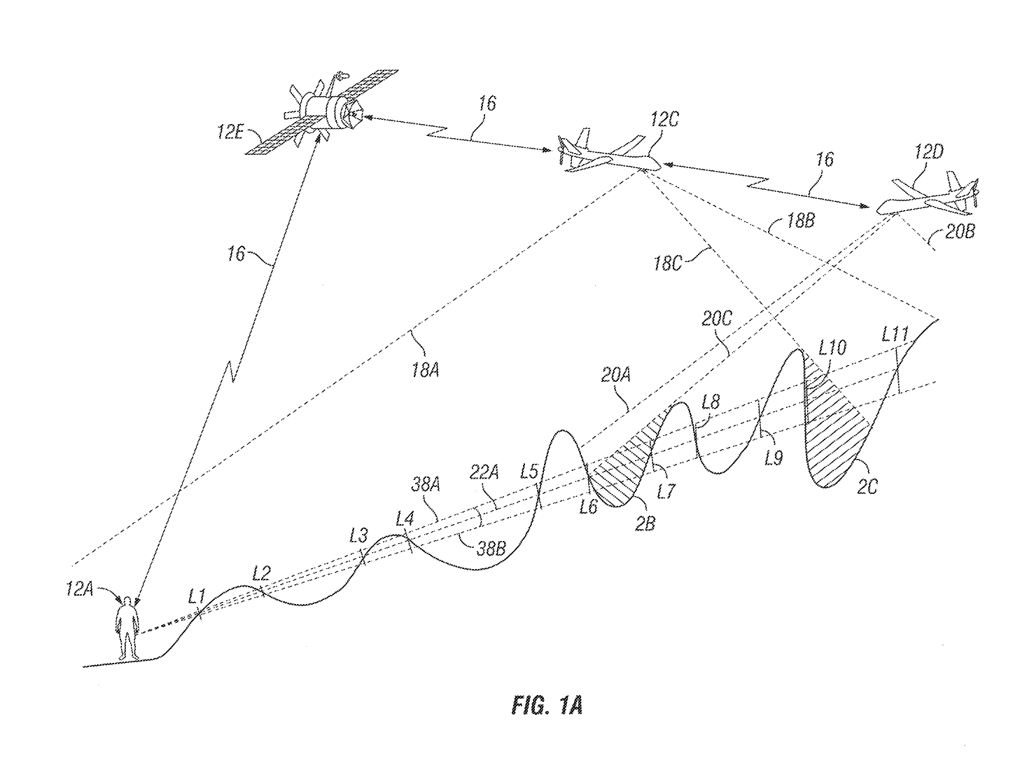

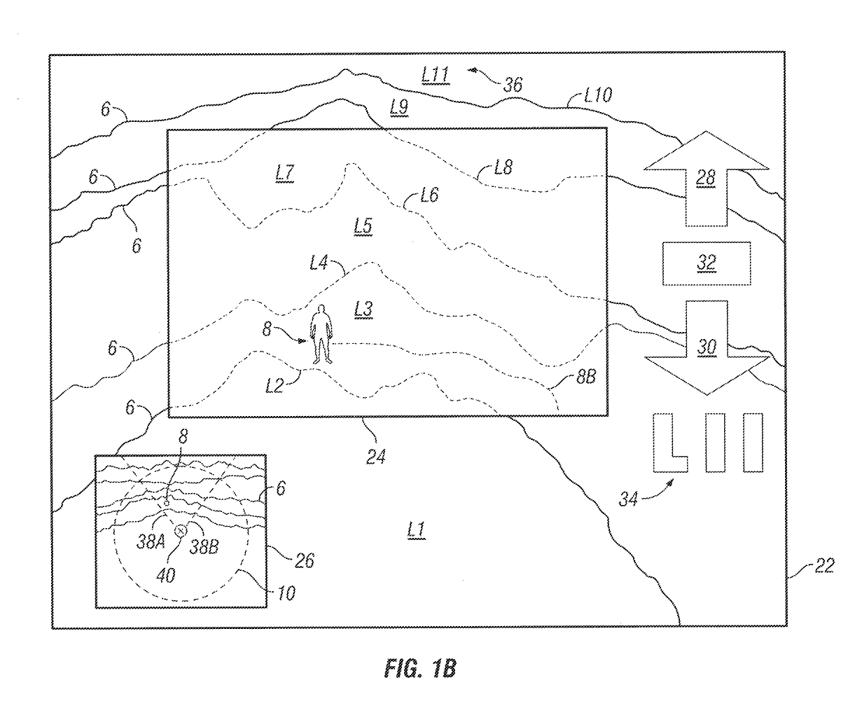

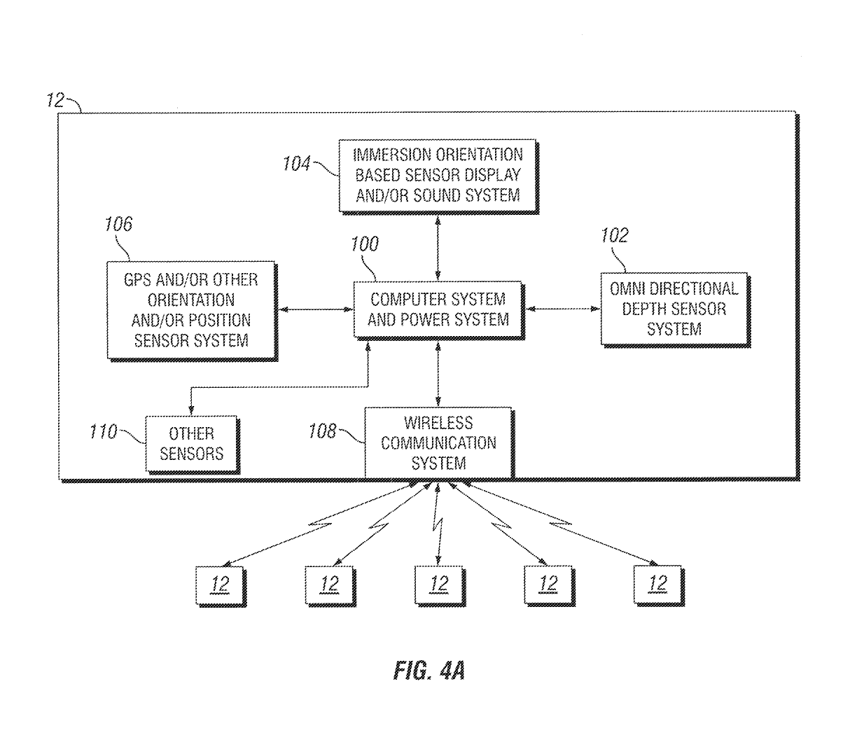

FIG. 1A shows a planar slice of a hilly mountainous terrain 6 with many occluding (blocking) valley layers labeled as “L1 through L11” viewed by person 12A where layer “L1” is not occluded to person 12A. These layers L2 through L11 can create significantly occluded regions from the unaided perspective view of a dismounted (on foot) person 12A shown. Unknown friends, foes, or other objects, can reside in these occluded spaces in real time and can have an element of surprise that can have a significant impact on the performance objectives of a dismounted person 12A when what is in these regions in real time is not known. When the dismounted person 12A looks at the hilly terrain 6, with his or her unaided eyes only, the dismounted person 12A can only see surface layer L1 while the layers L2 through L11 are significantly blocked (occluded). When the dismounted person 12A has the extra-sensory perception sharing system 12 (block diagram shown in FIG. 4A) that uses a Heads Up Display (HUD) that can also be a hand held device with orientation sensors and head tracking sensors or a Head Mounted Display (HMD), many or all of the occluded layers can be viewed by the dismounted person 12A depending on what other force capability and unknown terrain identification systems are within communications range of each other. The occluding layers can have their images transferred from extra-sensory perception sharing system 12 (block diagram shown in FIG. 4A) units and transformed into the perspective of dismounted person 12A viewing edges 38A and 38B. For occluding surfaces L2, L4, L6, L8, and L10 the image displayed can be reversed and transformed from the sensor perspective such that the viewing is as if the mountain were transparent, while surfaces L3, L5, L7, L9, and L11 do not need to be reversed because the sensor perspective is from the same side as the dismounted person 12A.

The regions that are occluded, and that are also not in real time view of any extra-sensory perception sharing system 12, need to be clearly identified so that all participating systems are made well aware of the unknown zones or regions. These unknown regions can be serious potential hazards in war zones or other situations and need to be avoided or be brought within real time view of a unit using a three dimensional (3D) sensor system which can be a omni-camera, stereoscopic camera, depth camera, “Zcam” (Z camera), RGB-D (red, green, blue, depth) camera, time of flight camera, radar, or other sensor device or devices and have the data shared into the system. In order to share the data the unit can have the extra-sensory perception sharing system 12 but do not need to have an integrated onboard display, because they can be stand alone or remote control units.

From the “x-ray like” vision perspective of person 12A (“x-ray like” meaning not necessarily actual X-ray, but having the same general effect of allowing to see through what is normally optically occluded from a particular viewing angle) the viewable layers of occlusion L2 through L11 have a planar left and right HUD viewing angles with center of the Field Of View (FOV) of the HUD display are shown by 38A, 38B, and 22A respectively.

The “x-ray like” vision of person 12A of the occluded layers L2 through L11 can be achieved by other extra-sensory perception sharing systems 12 units that are within communications range of person 12A or within the network, such as via a satellite network, where person 12A can communicate with using extra-sensory perception sharing system 12 (FIG. 4A), where camera image data or other sensor data can be transferred and transformed based on viewing angle and zoom level. Shown in FIG. 1A is satellite 12E in communications range of person 12A where person 12A can communicate with satellite 12E using extra-sensory perception sharing system 12 (shown in FIG. 4A) using wireless satellite communications signal 16. Satellite 12E is in communications with drone 12C to the left of FIG. 1A that has left planar edge sensor view 18A and right planar edge sensor view 18B. The part of the hilly mountainous terrain 6 that has a ridge between layers L9 and L10 creates a real-time occlusion space 2C for left drone 12C where occlusion plane edge 18C of left drone 12C is shown where real-time sensor data is not known, and thus can be marked as a hazard zone between L10 and L11 if all participating extra-sensory perception sharing systems 12 cannot see this space 2C in real time. The hilly mountainous terrain 6 where left drone 12C is occluded from seeing space 2C in real time, prior satellite or other reconnaissance data can be displayed in place, weighted with time decaying magnitude of confidence based on last sensor scan over this space 2C. If there is no other extra-sensory perception sharing systems 12 that can see (via sensor) space 2C in real time then this space can be clearly marked as unknown with a time decaying confidence level based on last sensor scan of space 2C.

A field commander can, out of consideration of potential snipers, or desire to enhance knowledge of unknown space 2C can call in another drone 12D to allow real time sensor coverage of space 2C and transfer data to other extra-sensory perception sharing systems 12, thus creating the ability of making space 2C potentially less of an unknown to other extra-sensory perception sharing systems 12 in the area and can be marked accordingly. Since in FIG. 1A the right drone 12D is in un-occluded (not blocked) view of space 2C with right drone 12D left edge sensor field of view 20A and right drone 12D right edge sensor field of view 20B, region 2C can be scanned in real time with right drone 12D sensor(s) and this scanned data of space 2C can be shared in real time with other extra-sensory perception sharing systems 12 and no longer has to be marked as significantly unknown. Right drone 12D has its own sensor occluded space 2B shown between part of the hilly mountainous terrain 6 that has a valley between layers L6 and L7 but because left drone 12C is in real time view of space 2B the left drone 12C can share real time sensor data of this space 2B with right drone 12D through wireless signal 16 as well as with person 12A through wireless signal 16 to/from left drone 12C and to/from satellite 12E using wireless signal 16 and down to person 12A through wireless signal 16 through satellite 12E. Space 2C data can also be shared between extra-sensory perception sharing systems 12 in a similar manner, thus eliminating most all occluded space for person 12A enabling person 12A to see all the occluded layers L2 through L11. If a drone moves out of view of any layer in real-time, this layer can be marked accordingly as out of real-time view by any means to make it clear, such as changing transparent color or any other suitable method to identify unknown space in real time. Alarms can also be sounded when coverage drops unknown space increases within expected enemy firing range. Unknown spaces can show last scan data, but are clearly marked and/or identified as not real time. If a possible target is spotted, such as via infrared signature, and it moves out of sensor range, an expanding surface area of unknown location can be marked and displayed until next ping (signature spotting) of target.

FIG. 1B shows the Heads Up Display (HUD) or Head Mounted Display (HMD) perspective view of the person 12A shown in FIG. 1A of the hilly mountainous terrain 6 edges with occluding layers L1 through L11 shown clear except for layer L4 and layers up to “L11” are available for viewing. The person 12A can select either side of the ridge to view, where the side of the occluded saddle (or dip) in the mountainous space 6 facing opposite of person 12A can have the reverse image layered onto the mountain surface, while the side of the saddle farthest can have the image layered onto the mountain surface as if seen directly. Individual layers can be selected, merged, or have a filtered view with just objects with certain characteristics shown such as objects that have a heat signature as picked up by an infrared (IR) camera or other unique sensor, or objects that have detected motion, or are picked up by radar or any other type of desired filtered object detected by a sensor of suitable type. Tracked targets inside occlusion layers can be highlighted, and can show a trail of their previous behavior as detected in real time. On occlusion layer L4, sniper 8 is shown as discovered, tracked, and spotted with trail history 8B. If drone 12D (of FIG. 1A) was not present, unknown occluded zone 2C (of FIG. 1A) between layers L10 and L11 can be marked as unknown with a background shading, or any other appropriate method to clarify as an unknown region in “x-ray” like viewing area 24 or elsewhere or by other means in FIG. 1B.

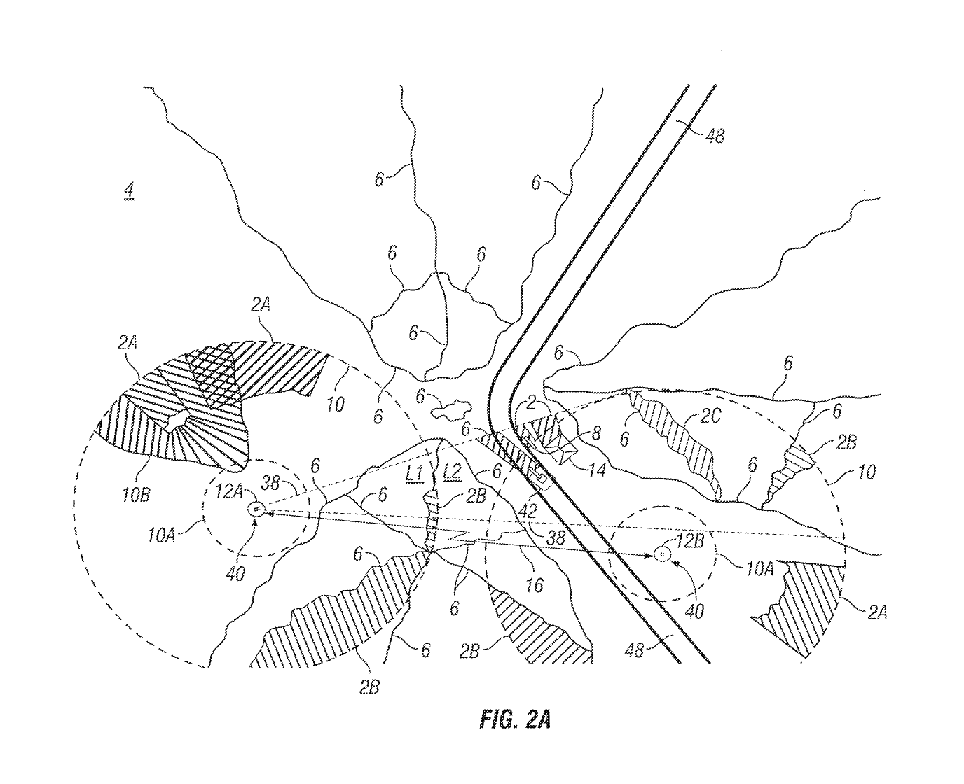

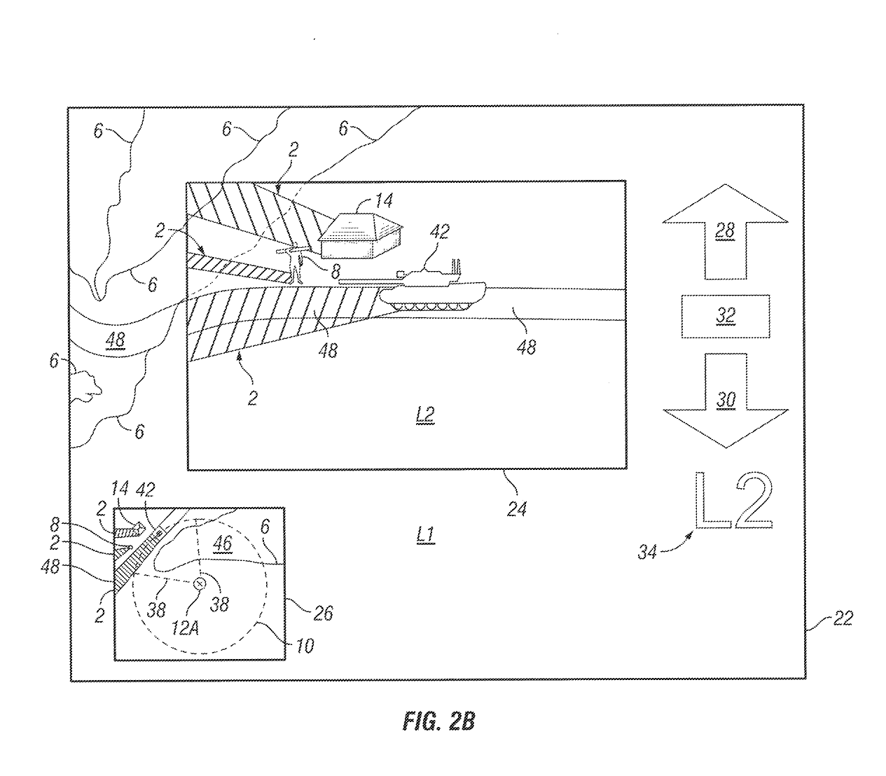

FIG. 2A shows a mountainous terrain with three canyon valleys merged together where two person units, 12A and 12B, are shown. Unit 12A on the left of the figure, and one unit 12B, on the right of the figure are displayed with their sensor range capabilities as a dotted lined circle 10. Units 12A and 12B also display their weapons range capability as illustrated by the dotted circles 10A around the unit centers 40. Possible sniper 8 positions within occluded zone 2A next to unit 12A are shown with their corresponding predicted firing range space capabilities 10B. If a fix on a sniper 8 or other threat is identified, the real firing range space capability can be reduced to the range from real time fix.

This map of FIG. 2A is only shown in two dimensions but can be displayed in a Heads Up Display (HUD) or other display in three dimensions and in real time as well as display future probable movements for real-time adaptive planning. The system can display firing range 10B from occluded edges if the weapons held by an adversary have known ranges, by taking each occluded edge point for each point along the edge and drawing an arc range on its trajectory based on terrain and even account for wind conditions. By drawing the weapon ranges 10B, a unit can navigate around these potentially hazardous zones. Small slopes in land, or land bumps, rocks, or other terrain cause occlusion zones 2A (shown as shaded), as well as convex mountain ridges 6 produce occlusion zones 2B as well as occlusions from side canyon gaps 2C. Units 12A and 12B are able to communicate, cooperate, and share data through wireless signal 16 that can be via a satellite relay/router or other suitable means and can be bidirectional. Concave mountain ridges 6 generally do not produce occlusion zones 2 as shown on the two ridges 6 between units 12A and 12B where wireless signal 16 is shown to pass over.

Unit 12A on the left of FIG. 2A is shown with HUD viewing edges 38 (HUD view is shown in FIG. 2B) looking just above unit 12B in FIG. 2A where occlusion layers L1 and L2 are shown, where L1 occludes view from unit 12B while L1 is visible by unit 12A. Occlusion layer L2 is viewable by unit 12B and is occluded by unit 12A. Near unit 12B is road 48 where a tank 42 casts an occlusion shadow 2. By tank 42, a building 46 and a person on foot 44 are also in view of unit 12B but also cast occlusion shadows 2 from unit 12B sensor view. The occluded unknown regions 2, 2A, 2B, and 2C are clearly marked in real time so users of the system can clearly see regions that are not known.

In FIG. 2B a see through (or optionally opaque if desired) HUD display 22 with “X-ray” like view 24 that penetrates the occlusion layer L1 to show layer L2 using real time perspective image transformation that would otherwise be blocked by mountain edge 6 where the tank 42 on road 48, person with weapon 8, and building 14 cast sensor occlusion shadows 2 marking unknown zones from sensor on unit 12B (of FIG. 2A). A field commander can use these occlusion shadows that are common amongst all fielded units to bring in more resources with sensors that can contribute to system knowledge to eliminate the occlusion shadows 2 thus reducing the number of unknowns, and reducing operational risks. An example birds-eye (overhead) view map 26 around unit 12A is shown in FIG. 2B with tank 42 on road 48 within unit 12A sensor range 10 along with person with weapon 8 and building 14 shown. Example occlusion layer controls and indicators are shown as 28, 30, 32, and 34, where as an example, to increase occlusion views level, of viewing arrow 28 is selected, or to decrease occlusion view level arrow 30 is selected, or to turn display off or on 32 is selected. The maximum occlusion levels available are indicated as “L2” 34.

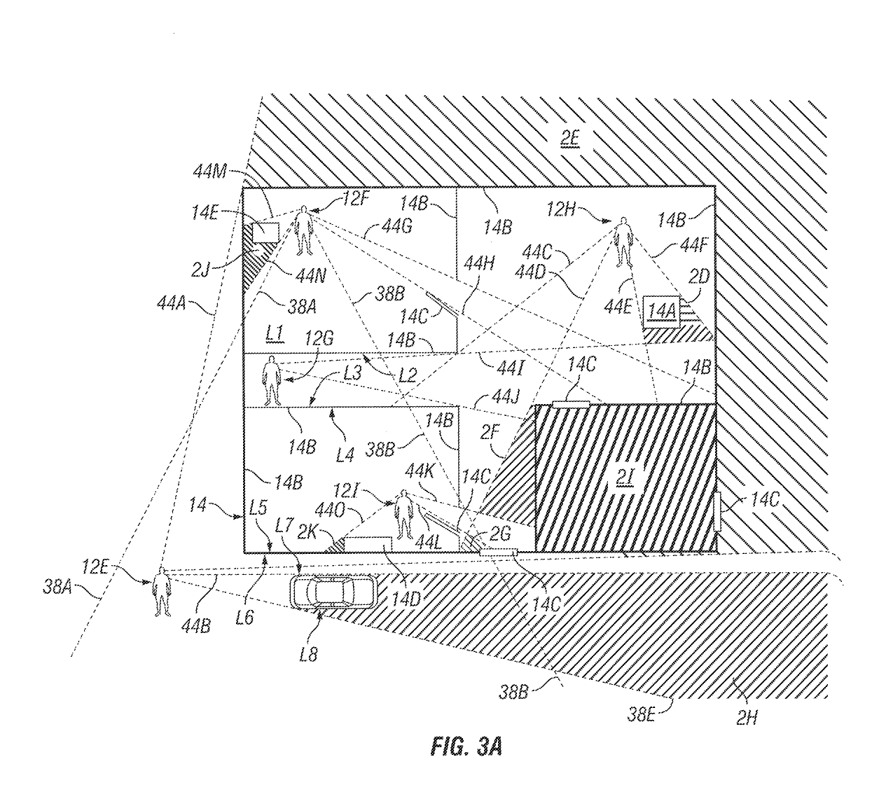

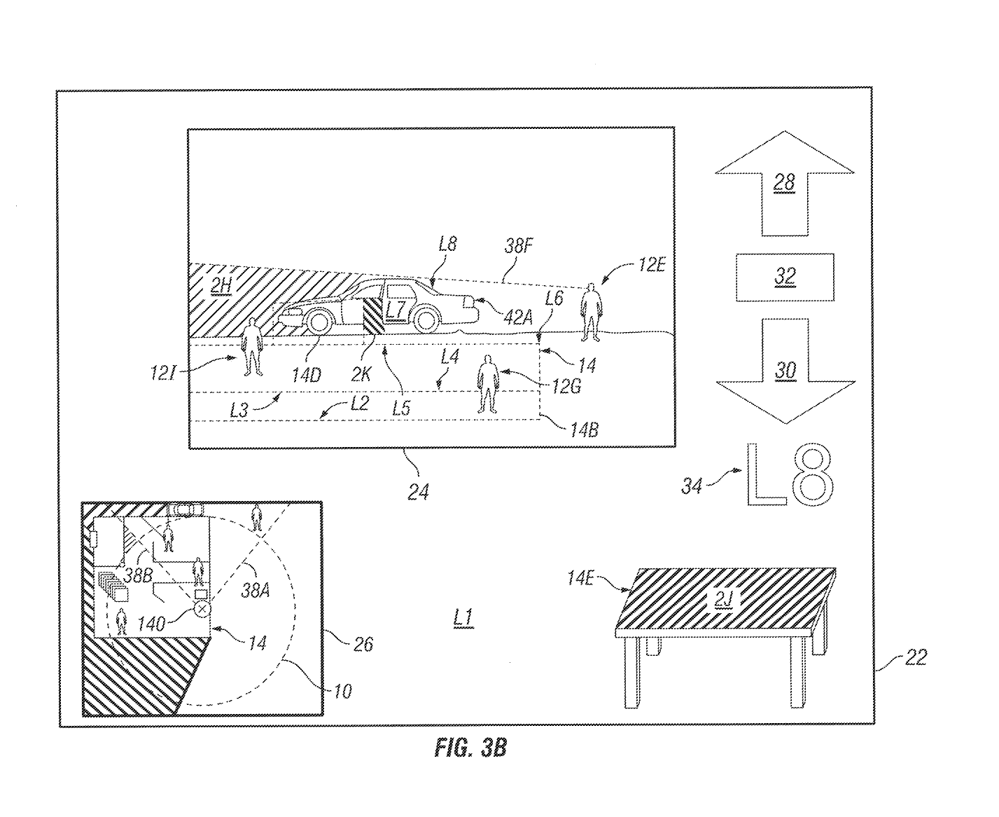

Shown in FIG. 3A is an example two dimensional (2D) view of a building 14 floor plan with walls 14B and doors 14C being searched by four personnel 12F, 12G, 12H, and 12I inside the building and one person 12E outside of the building 14 all communicating wirelessly (wireless signals between units are not shown for clarity). The inside person 12F is using the HUD “x-ray” like view (as shown in FIG. 3B) with “x-ray” view edges 38A and 38B starting from inside occlusion layer L1 formed by room walls. Inside person 12F has occlusion view edges 44G and 44H caused by door 14C that identifies viewable space outside the room that inside person 12F is able to see or have sensors see. Inside person 12G is shown inside hallway where occlusion layer L2 and L3 is shown with respect to inside person 12F with occlusion edges 44I and 44J caused by wall 14B room corners. Inside person 12H is shown outside door of where person 12F is with occluded view edges identified as dotted lines 44C and 44D caused by room corners and 44E caused by building column support 14A and 44F also caused by building column support 14A. Person 12I next to cabinet 14D is shown inside occlusion layers L4 and L5 relative to person 12F with occlusion edges 44K and 44L caused by door 14C. Outside car 42A is shown as occlusion layer L7 and L8 as car edge nearest building 14 relative to inside person 12F. Each time a layer is penetrated from a line-of-sight ray-trace relative to an observer with an extra-sensory perception system 12, two layers of occlusion is added where perspective transformed video from each side of the occlusion can be shared within the systems.

Unknown regions of FIG. 3A that are occluded by all the personnel are identified in real time as 2D, 2E, 2F, 2G, 2H, 2I, 2J, and 2K. These regions are critical for identifying what is not known in real time, and are determined by three dimensional line-of-sight ray-tracing of sensor depth data (such as by 3D or-ing/combining of depth data between sensors with known relative orientations and positions). Data from prior scan exposures of these regions can be provided but clearly marked as either from semi-transparent coloring or some other means as not real time viewable. Occluded region 2J is caused by table 14E near person 12F and is occluded from the viewing perspective of person 12F by edges 44M and 44N. Occlusion 2D is caused by building support column 14A and is shaped in real time by viewing perspective edges 44E and 44F of sensors on person 12H as well as sensor viewing perspective edges 44I and 44J of person 12G. Occlusion space 2F is formed by perspective sensor edges 44K and 44L of person 12I as well as perspective sensor edge 44D of person 12H. Occlusion space 2K is caused by cabinet 14D and sensor edge 44O from person 12I. Occlusion space 2I is formed by room walls 14B and closed door 14C. Occlusion space 2G is formed by perspective sensor edges 44L and 44K of person 12I and perspective sensor edge 44D of person 12H. Occlusion space 2H is caused by car 42A and perspective sensor edge 44B from outside person 12E along occlusion layer L7 as well as sensor edge 38E. Occlusion space 2E is caused by perspective sensor edge 44A from outside person 12E touching building 14 corner.

The occlusion regions are clearly marked in real time so that personnel can clearly know what areas have not been searched or what is not viewable in real time. The system is not limited to a single floor, but can include multiple floors, thus a user can look up and down and see through multiple layers of floors, or even other floors of other buildings, depending on what data is available to share wirelessly in real time and what has been stored within the distributed system. A helicopter with the extra-sensory perception sharing system 12 hovering overhead can eliminate occluded regions 2E and 2H in real time if desired. Multiple users can tap into the perspective of one person, say for example, inside person 12H, where different viewing angles can be viewed by different people connected to the system so as to maximize the real-time perceptual vigilance of person 12H. To extend the capability of inside person 12H robotic devices that can be tools or weapons with capabilities of being manipulated or pointed and activated in different directions can be carried by person 12H and can be remotely activated and controlled by other valid users of the system, thus allowing remote individuals to “watch the back” or cover person 12H.

In FIG. 3B a see-through HUD display view 22 is shown with “x-ray” like display 24 showing view with edges defined by 38A and 38B from person 12F of FIG. 3A where all occlusion layers L1 through L8 are outlined and identified with dotted lines and peeled away down to L8 to far side of car 42A with edge of car facing building 14 shown as layer L7 with semi-transparent outlines of tracked/identified personnel 12I and 12G inside the building 14 and person 12E outside the building 14. Shown through the transparent display 22 is table 14E inside room where person 12F resides. Semi-transparent outline of cabinet 14D is shown next to car 42A with occlusion zone 2K shown. A top level (above head) view of the building 14 floor plan 26 is shown at the bottom left of the see-through display 22 with inside person 12F unit center 40 range ring 10 which can represent a capability range, such as a range to spray a fire hose based on pressure sensor and pointing angle, or sensor range limit or other device range limit. The building 14 floor plan is shown with all the other personnel in communications range inside the top level (above head) view 26 of the floor plan. Occlusion layer display controls are shown as 28 (up arrow) to increase occlusion level viewing, 30 (down arrow) to decrease occlusion level viewing, and display on/off control 32 and current maximum occlusion level available 34 shown as L8.

FIG. 4A is an example hardware block diagram of the extra-sensory perception sharing system 12 that contains a computer system (or micro-controller) with a power system 100. Also included is an omni-directional depth sensor system 102 that can include an omni-directional depth camera, such as an omni-directional RGB-D (Red, Green, Blue, Depth) camera or a time of flight camera, or Z-camera (Z-cam), or a stereoscopic camera pairs, or array of cameras. The extra-sensory perception sharing system 12 can be fixed, stand alone remote, or can be mobile with the user or vessel it is operating on. The omni-directional depth sensor system 102 is connected to the computer and power system 100. A GPS (Global Positioning System) and/or other orientation and/or position sensor system are connected to computer system and power system 100 to get relative position of each unit. Great accuracy can be achieved by using differential GPS or highly accurate inertial guidance devices such as laser gyros where GPS signals are not available. Other sensors 110 are shown connected to computer system and power system 100 which can include radar, or actual X-ray devices, or any other type of sensor useful in the operation of the system. Immersion orientation based sensor display and/or sound system 104 is shown connected to computer system and power system 100 and is used primarily as a HUD display, which can be a Head Mounted Display (HMD) or hand held display with built in orientation sensors that can detect the device orientation as well as orientation of the user's head. A wireless communication system 108 is shown connected to computer system and power system 100 where communications using wireless signals 16 are shown to connect with any number of other extra-sensory perception sharing systems 12. Data between extra-sensory perception sharing systems 12 can also be routed between units by wireless communications system 108.

Shown in FIG. 4B is an example general system software/firmware flow chart of code running on processor(s) of computer and power system 100 (of FIG. 4A) or any other suitable component within extra-sensory perception sharing system 12 (or FIG. 4A). The process starts at process start 112 and initializes at process block 114 where sensors are read at process block 116, where transfer and process of sensor data to/from cooperating units occurs at process block 118. The display zoom selected occluded level image per orientation occurs at process block 120 where annunciation of selected occluded level sound or other immersion sensor per orientation of user occurs at process block 122. Displaying and computing capabilities data occurs at process block 124 where weapons or other capability range rings are computed and identified. Display and computation of unknown regions and confidence data is done at process block 126, where the display and map (image mapping) and other data are updated on the display at process block 128 as shown through process connector “A” 136. A shutdown decision occurs at condition block 130 where if there is no shutdown, the process continues to the read sensor process block 116 through connector 134 or if a shutdown does occur, the system shuts down at process termination block 132.

### REFERENCE NUMERALS

L1 . . . L11 occlusion layers
2 occluded or unknown zone
2A occluded region caused by small bump in land in otherwise flat area of land p0 2B occluded region due to mountain ridge
2C occluded gap due to mountain ridge
2D occlusion created by building column
2E occluded region caused by building perimeter
2F occlusion caused by building corner
2G occlusion caused by building corner and door edge
2H occlusion caused by car
2I occlusion caused by building room wall
2J occlusion caused by low laying table
2K occlusion caused by cabinet
4 space out of range
6 mountain ridge line
8 sniper/unknown person with weapon
8B tracked sniper trail
10 sensor range capability ring
10A maximum effective weapon range (may be some other shape due to terrain, prevailing wind/current), or maximum effective visual, sensor or other equipment range.
10B known assailant weapon range capability from real time occlusion region
12 extra-sensory perception sharing system
12A dismounted person (infantry, vehicle, or otherwise)
12B dismounted person (infantry, vehicle, or otherwise)
12C drone left
12D drone right
12E dismounted person unit outside building
12F dismounted person unit inside building using HUD to view beyond walls
12G dismounted person
14 building or vehicle obstructions that create occlusion zones
14A building column
14B building wall
14C building door
14D building bookcase
14E low laying table
16 wireless signal(s) between cooperating units 12 (can be via satellite, VHF, etc.)
18A left extreme field of view of drone 12C
18B right extreme field of view of drone 12C
18C occluded edge of drone 12C sensor view
20A left extreme field of view of drone 12D
20B right extreme field of view of drone 12D
20C occluded plane of drone 12D
22 See through Heads Up Display (HUD—with head orientation sensors)
22A see through HUD view center of Field Of View (FOV) angle
24 occlusion layer display (shows image projections behind occlusion)
26 birds eye view over head display
28 increase occlusion display depth select control (can use eye track or virtual keyboard to select)
30 decrease occlusion display depth select control (can use eye track or virtual keyboard to select)
32 occlusion display toggle: show all layers, show no layers (can use eye track or virtual keyboard to select)
34 occlusion layers number displayed
38 occlusion layer display field of view edge, of unit 12A
38A HUD view left edge from dismounted unit
38B HUD view right edge from dismounted unit
38C unit 12E occluded by building 14 corner
38D unit 12E occluded by car edge on L7 side
38E unit 12E occluded by car edge on L8 side
38F unit 12E occluded by top edge of car between layers L7 and L8
40 unit center
42 tank
42A car
44A dismounted unit 12E left occlusion edge to building 14
44B dismounted unit 12E right occlusion edge to car 42A
44C left occlusion building corner edge from dismounted unit 12H
44D occlusion edge to building corner from dismounted unit 12H
44E building column 14A occlusion left edge
44F building column 14A occlusion right edge
44G dismounted unit 12F top occlusion edge to door 14C
44H dismounted unit 12F bottom occlusion edge to door 14C
44I dismounted unit 12G top occlusion edge to building corner
44J dismounted unit 12G bottom occlusion edge to building corner
44K dismounted unit 12I top occlusion edge to door 14C
44L dismounted unit 12I bottom occlusion edge to door 14C
44M dismounted unit 12F table 14E occlusion left edge
44N dismounted unit 12F table 14E occlusion right edge
44O dismounted unit 12I cabinet 14D occlusion edge
100 computer system and power system
102 omnidirectional depth sensor system
104 orientation based sensor display and/or sound system
106 GPS and/or other orientation and/or position sensor system
108 wireless communication system
110 other sensors

### OPERATION

Given unit position and orientation (such as latitude, longitude, elevation, & azimuth) from accurate global positioning systems or other navigation/orientation equipment, as well as data from accurate and timely elevation and/or topographical, or other databases, three dimensional layered occlusion volumes can be determined and displayed in three dimensions in real time and shared amongst units where fully occluded spaces can be identified, weapons capabilities, weapons ranges, weapon orientation determined, and marked with weighted confidence level in real time. Advanced real-time adaptive path planning can be tested to determine lower risk pathways or to minimize occlusion of unknown zones through real time unit shared perspective advantage coordination. Unknown zones of occlusion and firing ranges can be minimized by avoidance or by bringing in other units to different locations in the region of interest or moving units in place to minimize unknown zones. Weapons ranges from unknown zones can be displayed as point ranges along the perimeters of the unknown zones, whereby a pathway can be identified so as to minimize the risk of being effected by weapons fired from the unknown zones.

I claim:

1. An occlusion/unknown region determination, sharing, and planning system comprising:
a. a database,
b. a 3D sensor,
c. an orientation sensor,
d. a wireless transceiver,
e. a computing system,
f. a control/interface code,
g. a real time ray-traced occluded zone tracking system,
h. a real time target tracking system,
i. a real time weapon range and direction data sharing and identification system, and
j. a real time force capability range calculation and display system.
